(19) United States
(12) Patent Application Publication
(10) Pub. No.: US 2026/0265616 A1
(43) Pub. Date: Sep. 10, 2026

(54) Apparatus And Method For Pyrolyzing Fluid Hydrocarbons

(71) Applicant: BlueAlp Innovations B.V., Eindhoven (NL)

(72) Inventors: Sem HEIJMANS, Eindhoven (NL); Rik GOLDSMITS, Eindhoven (NL); Teunis Christiaan VAN DER REE, Groot-Ammers (NL); Guus VAN ROSSUM, Eindhoven (NL)

(73) Assignee: BlueAlp Innovations B.V., Eindhoven (NL)

(21) Appl. No.: 19/164,728

(22) PCT Filed: Mar. 15, 2024
(86) PCT No.: PCT/EP2024/057053

§ 371 Date: Sep. 12, 2025

(30) Foreign Application Priority Data
Mar. 15, 2023 (NL) 2034348

(51) Int. Cl. C10G 7/00; B01J 6/00

(52) U.S. Cl. CPC C10G 7/00; B01J 6/008; C10G 2300/1003

(57) ABSTRACT

The invention relates to an apparatus for pyrolyzing fluid hydrocarbons to one or more hydrocarbon products, the apparatus comprising:
at least one recycle pump for forwarding fluid hydrocarbons; and
at least one recycle heat exchanger providing at least one tube for the fluid hydrocarbons to pass;
wherein the at least one recycle pump and/or the recycle heat exchanger are configured to establish a flow velocity of at least 1 m/s of the fluid hydrocarbons inside the at least one tube.

### FIELD OF THE INVENTION

The invention generally concerns methods and apparatuses to process waste plastics by means of pyrolysis, as well as the products obtained thereby. More specifically, the invention concerns an apparatus and a method for further cracking pyrolysis temperature fluid hydrocarbons.

### BACKGROUND OF THE INVENTION

Large quantities of waste plastics are generated in the present society. While recycling of plastics is becoming ever more efficient and effective, it is still the case that much of the waste plastic cannot be effectively or efficiently recycled and is disposed of to landfill sites where it takes many years to degrade, or it may be lost to the environment where it can be damaging to ecosystems.

Plastic materials are however made of essentially useful compounds that can be used as is and/or converted for (re)use. For example, fuels such as diesel may be derived from waste plastics, or waste plastics may be converted to raw material suitable for synthesis of new materials, such as new plastics, other hydrocarbon materials, or similar. Materials recovered from waste plastics may be useful to at least partially replace hydrocarbons more traditionally obtained from natural gas or mineral oils.

The output of plastic-to-chemical plants typically includes hydrocarbons that are liquid at 25° C., optionally retrieved in fractions such as a light hydrocarbon fraction (LHC) and a heavy hydrocarbon fraction (HHC), char, and non-condensables (gases). Currently, the liquid hydrocarbon fraction, LHC, HHC, or mixtures thereof, are the most desirable products, however, this is market dependent.

LHC and HHC fractions are required by industry to meet certain chemical and physical specifications such as vapor pressure, initial boiling point, final boiling point, Flash point, viscosity, cloud point and cold filter plugging point. Different qualities may be desired by different customers or end-uses, but it is important that plastic-to-chemical plants produce product of stable quality. The final quality of the product fractions is controlled by a distillation column such as those well-known and commonly used in the petrochemical industry. It is desirable that the fractions are relatively pure such that light hydrocarbons fraction and heavy hydrocarbons do not contain large portions of high boiling point compounds. Such high boiling point compounds can increase cold filter plugging points, cloud point and are often unacceptable to pyrolysis oil purchasers.

In plastic-to-chemical plants, feedstock plastics, which may comprise for the most polyethylene and polypropylene for domestic sources, form the input. These plastics made up of very long chain hydrocarbons are then cracked into shorter chains, forming a wide spectrum of molecules with a variety of chain lengths. These mixtures can be distilled into various temperature-determined fractions as is known.

A known process in the art for converting waste plastic to, among other things diesel, is the thermochemical breakdown process of pyrolysis. Pyrolysis is the thermal decomposition of the waste plastics in an inert atmosphere. In effect, the long polymer chains of the plastic's polymers are cracked through heating, resulting in shorter hydrocarbon chains, which are generally more useful as a product.

Pyrolysis is a preferred method of performing thermochemical break down of waste plastic materials. Various attempts to provide technically and cost-effective pyrolysis of waste plastic have been attempted previously.

Technically useful results have been achieved by the technologies discussed in patent publications US2018/0010050A1 and WO2021/053139A1, the contents of which publications are incorporated herein by reference.

US2018/0010050A1 discusses a method for recovering hydrocarbons from plastic wastes by pyrolysis without the use of catalysts, in particular polyolefin-rich waste. The process involves melting the plastic waste in two heating devices and mixing a stream derived from a cracking reactor with the incoming molten plastic waste of a first heating device. The heated, molten plastic is passed to a cracking reactor where the plastic materials are cracked. Subsequent thereto the cracked materials are distilled into diesel and low boilers.

WO2021/053139A1 which offers a number of advancements in relation to US2018/0010050A1, discusses, among other matters, a method for breaking down long-chain hydrocarbons from plastic-containing waste, comprising providing material containing long-chain hydrocarbons; heating a specific volume of the material containing long-chain hydrocarbons to a cracking temperature, at which cracking temperature the chains of hydrocarbons in the material start cracking into shorter chains; and for the specific volume having a temperature above the cracking temperature, exposing the specific volume to heat which is less than or equal to 50° C. above the temperature of the specific volume. After the specific volume of the material has been exposed to heat, WO2021/053139A1 passes the partially cracked stream of molten plastic to a gas-liquid separation structure. The separation structure, also referred to as reactor, includes a separation zone containing a gas-liquid phase boundary, and a settling zone for heavy hydrocarbons and/or char particles, as well as potentially other solids such as aluminium, sands, dirt, etc., to accumulate.

EP2876146B1 discusses tested technology in which a process for recovering hydrocarbons from polyolefin plastic recyclables by means of pyrolytic cracking comprises: introducing the plastic recyclables into a mixing vessel under inert gas and mixing with diesel oil, removing water vapor in a first heating zone, removing acidic gases in a second heating zone, liquefying those not yet melted plastic recyclables in a third heating zone, cracking of the plastic recyclables in a cracking reactor at approx. 400 degrees Centigrade, partial condensation to prevent the discharge of paraffins, fractionation of the cracked products.

While the present invention has as general aim the overall system improvement of such pyrolysis processes and apparatuses, aspects of improvement may preferably include one or more of the following.

### SUMMARY

While the invention is defined in the independent claims, further aspects of the invention are set forth in the dependent claims, the drawings and the following description.

In an aspect it is an object of the present invention to provide alternatives, and preferably improvements for pyrolysis processes and apparatuses. These may address the separation of gas, liquid and solid particles in a cracking stream of plastic and/or the system for cracking of long chained hydrocarbons. It is also an object of the present invention to provide an improved method for breaking down long chained hydrocarbons.

In another aspect of the invention, it may be desirable to improve reliability of processes.

In another aspect of the invention, it may be desirable to improve or limit downtime of the system.

### BRIEF DESCRIPTION OF THE DRAWINGS

The features and advantages of the invention will be appreciated upon reference to the following drawings, in which:

FIG. 1 shows an assembly for cracking long chained hydrocarbons;

FIG. 2 schematically illustrates a reheating recycle loop for a separator vessel;

FIG. 3 shows an embodiment of a separator vessel and a recycle loop;

FIG. 4 shows an embodiment of a separator vessel and a recycle loop;

FIG. 5 shows an embodiment of a separator vessel and a recycle loop;

### DESCRIPTION AND ILLUSTRATIVE EMBODIMENTS

It will be appreciated that for simplicity and clarity of illustration, where considered appropriate, reference numerals may be repeated among the figures to indicate corresponding or analogous elements or steps. In addition, numerous specific details are set forth to provide a thorough understanding of the embodiments described herein. However, it will be understood by those of ordinary skill in the art that the embodiments described herein may be practiced without these specific details. Furthermore, this description is not to be considered as limiting the scope of the embodiments described herein in any way, but rather as merely describing the implementation of the various embodiments described herein. The following is a description of certain embodiments of the invention, given by way of example only and with reference to the drawings.

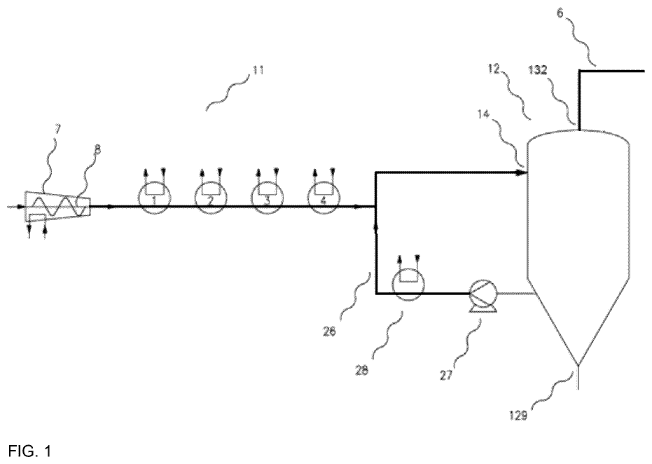

FIG. 1 shows an apparatus comprising a heating device 11 and a separator vessel 12. The heating device 11 is in communication with the separator vessel 12 to feed fluids (liquids and gases) into the separator vessel 12. More specifically, the heating device 11 feeds fluids containing (partially) cracked hydrocarbons in both gaseous and liquid states into the separator vessel 12 at pyrolysis temperatures.

Before further describing details of the depicted embodiment, general aspects of the invention are laid out below. To profitably run a plastic-to-chemical plant, maintenance cycles should be extended and maintenance downtime should be reduced. To extend maintenance cycles of a pyrolytic plastic-to-chemical plant it is not only important to reduce build-up of heavy hydrocarbons and carbon solids, but also to avoid fouling with heavy hydrocarbons, char particles and/or solid carbon, as well as potentially other solids such as aluminium, sands, dirt, etc. inside the piping of the plant. The inventors have realised that heat exchangers are particularly prone to fouling for two reasons: Firstly, they effect cracking of plastics and/or hydrocarbon chains and thus constitute the first location where any such solids can deposit and constitute fouling. Secondly, to increase surface to volume ratios of the fluid hydrocarbons, a single flow of fluid hydrocarbons is split into several, often increasing the cross section of the flow. The inventors understood that the increased cross section conforms with a reduction of the flow velocity of the fluid hydrocarbons inside the heat exchanger.

According to an aspect, an apparatus for pyrolyzing fluid hydrocarbons to one or more hydrocarbon products comprises:
at least one recycle pump for forwarding fluid hydrocarbons; and
at least one recycle heat exchanger providing at least one tube for the fluid hydrocarbons to pass;
wherein the at least one recycle pump and/or the recycle heat exchanger are configured to establish a flow velocity of at least 1 m/s of the fluid hydrocarbons inside the at least one tube. Such flow velocity helps maintaining solid particles in suspension while passing the recycle heat exchanger. These solid particles are then less likely to settle and foul in the heat exchanger. In various embodiments this reduces downtimes of the system or parts of it. While particularly described by reference to a recycle loop, the present invention is principally also applicable to other sections of the apparatus for pyrolyzing fluid hydrocarbons.

In this respect, once waste plastics material starts cracking, some shorter chains of hydrocarbon may change into the gas phase and longer chains of hydrocarbon remain in a liquid phase. The fluid hydrocarbons originating from the plastics material thus contain both, the hydrocarbons in the gas phase and in the liquid phase.

In various embodiments the recycle heat exchanger comprises a heat exchange surface for the fluid hydrocarbons to contact while passing the recycle heat exchanger, wherein the heat exchange surface provides a minimum heat exchange surface area of at least 8 m² per predetermined throughput of 6000 kg/h of fluid hydrocarbons passing the recycle heat exchanger in operation.

In various embodiments the apparatus further comprises a separator vessel comprising:
a recycle inlet arranged to receive pyrolysis temperature, gaseous and fluid hydrocarbons from the at least one recycle heat exchanger;
an upper outlet for exit of gaseous material; and
a lower outlet for exit of fluid hydrocarbons;
   wherein the lower outlet is configured to pass the fluid hydrocarbons to the at least one recycle pump.

In various embodiments the separator vessel further comprises a separator vessel inlet arranged to pass fresh feed pyrolysis temperature, gaseous and fluid hydrocarbons into the separator vessel;

wherein the recycle heat exchanger comprises a heat exchange surface for the fluid hydrocarbons to contact while passing the recycle heat exchanger, wherein the heat exchange surface provides a minimum heat exchange surface area of at least 80 m² per predetermined throughput of 3000 kg/h of fresh feed fluid hydrocarbons entering the separator vessel in operation. This corresponds essentially to the minimum heat exchange surface area indicated above but by reference to the throughput of the separator vessel. The throughput of the separator vessel and of the throughput of the recycle loop of a relatively constant ratio, with the throughput through the recycle loop being at least eight times the throughput of fresh feed fluid hydrocarbons into the separator vessel in terms of weight, preferably between ten and twenty times the throughput of fresh feed fluid hydrocarbons into the separator vessel in terms of weight. In various embodiments, the temperature of the fluid hydrocarbons passing the recycle heat exchanger is then raised with between 3 and 15° C. in a single pass, preferably between 4 and 14° C., more preferably between 5 and 13° C.

In various embodiments the apparatus is configured such that the flow ratio of the fluid hydrocarbons entering the separator vessel through the separator vessel inlet and the fluid hydrocarbons exiting the separator vessel through the lower outlet is between 1:1 and 1:20.

In various embodiments the at least one recycle pump comprises a fluid hydrocarbons inlet, wherein the separator vessel is configured to have an upper level of the fluid hydrocarbons of at least 7 meters above the fluid hydrocarbons inlet.

In various embodiments the apparatus comprises a recycle pipe, wherein the recycle pipe is configured to pass the fluid hydrocarbons from the lower outlet of the separator vessel to the at least one recycle pump, wherein the recycle pipe is configured to cool the fluid hydrocarbons while passing to the at least one recycle pump.

In various embodiments the apparatus comprises a carbon discharge point configured to dispose of heavy hydrocarbons, char particles and/or solid carbon from the separator vessel; and a carbon discharge density sensor adjacent to the carbon discharge point configured to determine a density of a volume of hydrocarbons inside the separator vessel adjacent to the carbon discharge point; wherein the carbon discharge point is configured to selectively dispose of the heavy hydrocarbons and/or char particles dependent on a density of the volume of hydrocarbons. In various embodiments a difference in density between the recycle loop and the carbon discharge point indicates a share of char particles in the hydrocarbons at the carbon discharge point. This is because different compositions of hydrocarbons can lead to different densities of hydrocarbons in the separator vessel. Only measuring the density at the carbon discharge point can thus deliver very different values independently of the share of char particles at the carbon discharge point. The density of the hydrocarbons in the recycle loop has been observed to provide a sufficient indication of the density in the bulk of the hydrocarbons in the separator vessel. Comparing the density at the carbon discharge point and the density in the recycle loop indicates or at least provides a rough estimate of the share of heavy hydrocarbons and/or char particles accumulated at the carbon discharge point. In various embodiments, a frequency of carbon discharge at the carbon discharge point is adjusted according to the difference in density between the recycle loop and the carbon discharge point. In various embodiments heavy hydrocarbons and/or char particles are discharged when the difference in density between the recycle loop and the carbon discharge point exceeds a threshold.

In various embodiments the at least one recycle heat exchanger is configured to expose the fluid hydrocarbons to a temperature not more than 50° C. above the temperature of the respective fluid hydrocarbons, preferably not more than 30° C. above the temperature of the respective fluid hydrocarbons, more preferably not more than 20° C., most preferably not more than 15° C. The thus limited heating has shown to create low amounts of fouling and thus helps increasing maintenance cycles. This in turn helps avoiding downtime of the separator vessel and the recycle loop.

In various embodiments the apparatus comprises a back pressure control element configured to maintain the fluid hydrocarbons in the at least one recycle heat exchanger at a pressure of at least 2 bar, preferably at least 5 bar, more preferably at least 15 bar, wherein the back pressure control element is preferably arranged downstream of the recirculation heat exchanger. At higher pressures fluid hydrocarbons are less likely to change to the gas phase, thus improving temperature transfer.

In various embodiments the at least one recycle pump is a centrifugal pump and/or is arranged upstream of the recycle heat exchanger. Having a centrifugal pump particularly provides a cheaper and more reliable pump, as centrifugal pumps do not need to seal any chamber and thus fouling building up in the pump cannot interfere with any seal. Particularly when operating close to minimum flow velocities, centrifugal pumps usually provide a comparably constant flow such that flow velocities remain above the minimum flow velocity more reliably.

In various embodiments the apparatus comprises at least one heating element configured to selectively heat at least one section of the apparatus. This allows maintaining the temperatures of individual parts while switched of or removed from the flow of fluid hydrocarbons. Consequently, the material will not solidify in these parts.

In various embodiments the apparatus comprises at least two recycle heat exchangers, wherein the apparatus is configured to selectively pass fluid hydrocarbons exclusively through one of the at least two recycle heat exchangers.

In various embodiments the apparatus comprises at least one degassing section configured to reduce a share of hydrocarbons in a gas phase from the fluid hydrocarbons prior to entering the recycle pump. The degassing section can help reducing the amount of gas in the fluid hydrocarbons in the recycle loop. Having less gas in the fluid hydrocarbons improves functioning of the recycle pump as the recycle pump primarily forwards hydrocarbons in a liquid phase allowing for a more even load on the recycle pump. In various embodiments the degassing section operates on the basis of differences in the specific densities of hydrocarbons in the gas phase and in the liquid phase. In various embodiments the degassing section operates on the basis of gravity or centrifugal force.

In various embodiments the degassing section extends in a vertical direction and is configured to pass the fluid hydrocarbons downwards. In various embodiments the degassing section is configured to establish a flow velocity below a flow velocity in the remainder of the recycle loop before the recycle pump.

In various embodiments the degassing section is configured to establish a flow velocity of the fluid hydrocarbons of less than 0.054 m/s downwards, preferably less than 0.04 m/s, more preferably less than 0.03 m/s.

In various embodiments the apparatus comprises at least two degassing sections arranged in parallel to each other.

In various embodiments the apparatus comprises a recycle density sensor configured to determine a density of the fluid hydrocarbons passing to the recycle pump. The density is preferably determined with scintillator based technology such as the Hyperion™ from Tracerco.

In various embodiments the apparatus comprises a control element comprising a microprocessor and a memory, the memory storing instructions which, when executed by the microprocessor, operate any of the recycle pump, the recycle heat exchanger, the separator vessel, the carbon discharge point, and/or the back pressure control element. In various embodiments, the control element receives a signal from at least one of the recycle pump, the recycle heat exchanger, the separator vessel, the recycle density sensor, the carbon discharge density sensor and/or the back pressure control element for the microprocessor to process and particularly to control any of the recycle pump, the recycle heat exchanger, the separator vessel, the carbon discharge point, and/or the back pressure control element.

In various embodiments the microprocessor is configured to compare densities indicated by the carbon discharge density sensor and the recycle density sensor and to operate the carbon discharge point dependent on a result of comparing the densities.

In various embodiments a method for pyrolysis of fluid hydrocarbons comprises:
forwarding pyrolysis temperature, gaseous and fluid hydrocarbons through a heat exchanger; and
establishing a flow velocity of at least 1 m/s of the fluid hydrocarbons inside the at least one tube.

In various embodiments the method for pyrolysis of fluid hydrocarbons further comprises:
providing a separator vessel;
receiving pyrolysis temperature, gaseous and fluid hydrocarbons from the heat exchanger at a recycle inlet of the separator vessel;
exiting of gaseous material at an upper outlet of the separator vessel; and
exiting of fluid hydrocarbons at a lower outlet of the separator vessel;
   wherein the lower outlet passes the fluid hydrocarbons to the at least one recycle pump.

According to another aspect, a control element comprises a microprocessor and a memory, the memory storing instructions which, when executed by the microprocessor, operate the apparatus for pyrolyzing fluid hydrocarbons to carry out the method for pyrolysis of fluid hydrocarbons.

In various embodiments the heat exchanger exposes the fluid hydrocarbons to a temperature not more than 50° C. above the temperature of the respective fluid hydrocarbons, preferably not more than 30° C. above the temperature of the respective fluid hydrocarbons.

In some embodiments a feeding device 7 is arranged to fill material containing long chained hydrocarbons such as waste plastics as discussed, into the heating device 11. In some embodiments the feeding device 7 comprises an effector 8 for heating and/or forwarding the material containing long chained hydrocarbons. In some embodiments the effector is a screw auger 8 arranged to forward, and preferably also heat, the material containing long chained hydrocarbons. In some embodiments the screw auger 8 moves the material, and internal friction in the material causes the material to heat up and to melt. In further embodiments the feeding device 7 comprises a heating device such as an electrical heater or a heating device perfused by a heating medium such as thermal oil. The feeding device 7 drives the material containing long chained hydrocarbons to the heating device 11.

A substantial portion of the solid particulates will result from the pyrolysis reaction, and it is generation of char or coke particles as is common to pyrolysis. Other particulates may be present due to impurities in the initial plastic feed stream to the process, such as metal particles, and other detritus including for example organic matter. In the illustrated embodiment, four heating zones are illustrated. Each of the heating zones 1, 2, 3, 4, may be a heat exchanger, preferably a tube in shell heat exchanger. The heating zones 1, 2, 3, 4 provide a flow path for the fluid hydrocarbons containing long chained hydrocarbons. The heating zones 1, 2, 3, 4 continuously or gradually increase the exposure temperature along the flow path. Heating is preferably done gradually to reduce or avoid char formation through excessive temperature differentials.

The heating device 11 heats and melts plastic material feedstock, raising its temperature to a pyrolysis temperature. Within the context of this application, the pyrolysis temperature particularly is the minimum temperature for pyrolytic cracking of considerable amounts of a fluid hydrocarbons. Cracking may start in any of the heating zones 1, 2, 3, 4, with most cracking in the heating zones preferably occurring in heating zone 4, zone 4 being the hottest heating zone of the four. Pyrolysis temperatures may be 360° C. or greater, more preferably 390° C. or greater, preferably 395° C. or greater, preferably 400° C. or greater, more preferably 410° C. or greater. A pyrolysis temperature may be in the range of 360-550° C. more preferably 390-450° C.

The molten, partially pyrolyzed plastic material exits heating zone 4 at a pyrolysis temperature and passes into separator vessel 12 via separator vessel inlet 14.

In the separator vessel 12, incoming cracked gases and liquid separate. Gases will rise and exit to a distillation section, and liquids will fall to the bottom of the separator vessel 12. Heavy hydrocarbons return from the distillation section to the separator vessel 12.

The separator vessel 12 is associated with a recycle loop 26 provided to remove liquid, partially-pyrolyzed plastic material collected in the separator vessel 12. The recycle loop 26 comprises a recycle pump 27 and a recycle heat exchanger 28. The recycle pump 27 is configured to forward the fluid hydrocarbons from the separator vessel 12 and through the through the recycle heat exchanger 28. The recycle heat exchanger 28 reheats the forwarded fluid hydrocarbons to a pyrolysis temperature. The recycle loop 26 then returns the fluid hydrocarbons to the separator vessel 12. In the illustrated case of FIG. 1, fluid hydrocarbons returns to the separator vessel 12 together with fresh feed fluid hydrocarbons. In an alternative embodiment fluid hydrocarbons returns to the separator vessel 12 separately from fresh feed fluid hydrocarbons.

This recycle loop 26 increases the residence time for long-chain hydrocarbons at pyrolysis temperature so that they are subjected to further pyrolysis and broken down to shorter-chain hydrocarbons, eventually exiting via the distillation section.

The recycle loop 26 provides for reheating and reintroduction of heat to the separator vessel 12, such that the separator vessel 12 remains at a pyrolysis temperature. The heat is carried into the separator vessel 12 by the incoming reheated stream of material provided by the recycle loop 26.

In the illustrated, preferred embodiment, the separator vessel 12 is unheated, the term “unheated” meaning that the separator vessel 12 is not heated by any source other than heat carried by incoming heated material, for example, heated material entering the inner volume of the separator vessel 12 from a heating device such as the heating device 11 or another heating device as may be provided in the recycle loop 26.

It has been found to be useful to avoid provision of heating means on or in the separator vessel 12, as may be found in some prior attempts. This may assist in reducing char formation in the separator vessel 12 and reduces or avoids requirements for special agitation means. For example, it has been found in prior attempts that an internal heater, such as a heating coil, can cause fouling of pyrolyzing material at the surface of the heating element. That fouling may represent loss of product and may collect on the heating element requiring downtime for cleaning and maintenance. The same may be true in cracking reactor type vessels wherein the wall of the vessel is heated to bring or maintain the treated material at pyrolysis temperature. Charring may occur at the inner surface of the cracking reactor wall resulting in the need for complex mixing, cleaning and downtime. None the less, use of direct heating of the separator vessel, e.g. via a jacket or internal heat exchanger or heating coil, is not excluded from use in some embodiments or aspects of the invention and may be employed to a supply all or part of the heat requirement to the pyrolysis zone(s).

In the illustrated, preferred embodiment, the separator vessel 12 is not provided with an agitator, such as a stirrer or auger. Without wishing to be bound by theory, it is believed that inclusion of an auger or similar stirring device to agitate liquid in the separator vessel may be disadvantageous because it introduces complexity; forms a surface area upon which carbon/char can accumulate so reducing efficiency and requiring maintenance; and may interrupt flow patterns imparted by injection or materials. However, optionally as may be useful to improve mixing inside the separator vessel 12, an agitator inside the separator vessel 12 may be provided or is not excluded from some embodiments and aspects.

At the point of entering the separator vessel 12 via inlet 14 the fluid hydrocarbons are undergoing pyrolysis because it is at a pyrolysis temperature. The cracking of the plastic material results in generation of a wide spectrum of substances with a wide range of boiling points. The fluid hydrocarbons exiting the heating device 11 and entering the separator vessel 12 via inlet 14 comprises at least both gaseous and liquid components, the liquid component comprises at least partially cracked fluid hydrocarbons, possibly consists substantially of partially cracked fluid hydrocarbons. The liquid component may also comprise molten, uncracked plastic material. The fluid hydrocarbons exiting the heating device 11 and entering the separator vessel 12 via inlet 14 may additionally comprise silt and other solid detritus, for example, sand, aluminium, or other metal particles.

The illustrated separator vessel 12 is elongate and arranged substantially vertically. Non-vertical arrangements may also be envisioned, such as slanted or horizontal. Pyrolyzed gaseous material rises in the separator vessel 12 and liquid (partially) pyrolyzed material falls under gravity. In this manner, gaseous and liquid materials diverge and so separate in the separator vessel 12. In various embodiments, the separator vessel 12 has a cylindrical shape with a lower conical portion. The lower conical portion culminates at its lowest point in a carbon discharge point 129.

In various embodiments the separator vessel 12 comprises upper outlet 132 and a line 6 distillation section. The gaseous hydrocarbon materials rising in the separator vessel 12 discharge via the upper outlet 132 and pass via the line 6 to the distillation section. The distillation section is remote from the separator vessel 12 and is positioned downstream from the separator vessel 12. It is in fluid communication with the separator vessel 12 via the line 6.

The distillation section is configured to remove heavy fractions (lower higher point fractions) from the exiting gas, prior to the exiting gas being further passed to full distillation or condenser sections of the apparatus and process. In the distillation section the gas is cooled. As the gas is cooled, heavier fractions condense and can be collected.

The downstream distillation section can be designed according to industrial standards as known to those skilled in the art. The gases can be fractionated into gaseous fractions and liquid fractions. A liquid fraction may be stripped off as middle distillate, and a gaseous fraction may be stripped off as light boilers in a distillation unit. Hydrocarbon products from the distillation unit may comprise butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof; or any mixtures thereof. Hydrocarbon products may be saturated, unsaturated, straight, cyclic or aromatic. Further products may include non-condensable gases, comprising methane, ethane, ethene and/or other small molecules. The products may be a source of feedstock for steam crackers of the manufacture of plastics.

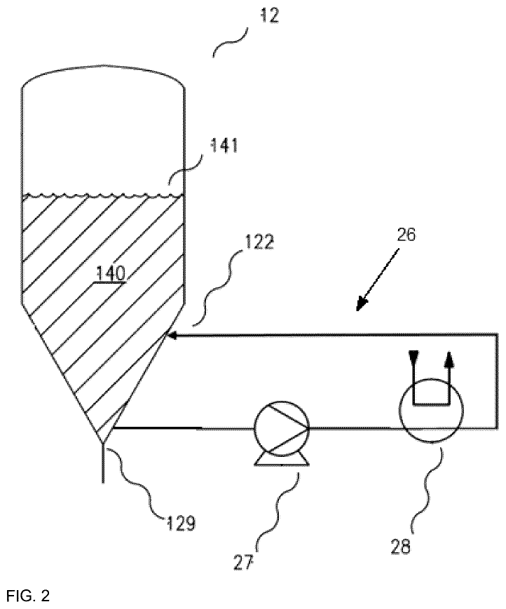

FIG. 2 shows a schematic illustration of the separation vessel 12 provided with the recycle loop 26. The recycle loop 26 is a source of heat energy to the separator vessel 12, preferably the main heat energy source to the separator vessel 12, such that particularly heat lost with the gases discharging through the distillation section is compensated.

Liquid 140 in the lower part of the separator vessel 12, e.g. comprising molten plastic and partially pyrolyzed hydrocarbons is pumped with the aid of the recycle pump 27 to the recycle heat exchanger 28. In various embodiments the recycle heat exchanger 28 is a shell and tube heat exchanger where the fluid hydrocarbons runs through the tubes, and a heating medium flows over the tubes through the shell to transfer heat from the heating medium to the fluid hydrocarbons. The recycle heat exchanger 28 (re)heats the liquid to a temperature above that of the temperature of the liquid in the separation vessel 12. For example, from about 410 to about 550° C., more preferably from about 410 to about 500° C., still more preferably from about 410 to about 450° C.

Since pyrolysis occurs at these temperatures, the pumped liquid stream will generate pyrolyzed gas and comprise a portion of gas. To reduce cavitation effects in the recycle pump 27 it is preferred that the recycle pump 27 is upstream of the recycle heat exchanger 28, so that the recycle pump 27 is presented predominantly with liquid phase. The (re) heated fluids pass back to the separator vessel 12, carrying heat energy with them, and heating the separator vessel 12 internally.

Due to the pyrolysis, carbon solids form in the heat exchanger 28 and tend to settle and clog the recycle heat exchanger 28. In various embodiments, the fluids inside the recycle heat exchanger 28 have a minimum velocity to maintain solid particulates in suspension and prevent sedimentation. Maintaining solid particulates in suspension reduces fouling of surfaces inside the tubes of the recycle heat exchanger 28 with carbon or char. The minimum velocity is about 1 m/s, preferably about 2 m/s at the inlet of the tubes of the recycle heat exchanger 28. That is, the recycle pump 27 and the recycle heat exchanger 28 are configured such that the minimum velocity is about 1 m/s, preferably about 2 m/s at the inlet of the tubes of the recycle heat exchanger 28. The velocity at the outlet of the heat exchanger 28 may be higher due to gas formation increasing volume and pressure.

The liquid gas mixture is then led by the recycle loop 26 to be tangentially injected at high velocity (e.g. about 5 m/s, more preferably about 8 m/s, most preferably about 10 m/s) into the crack reactor. The tangential injection may advantageously aid in providing a swirling or cyclone flow pattern in the fluids in the separation vessel 12. The liquid, gas mixture is preferably injected below the liquid level 141. This may assist in generating desired flow patterns in the gas/liquid zone in the separator vessel 12 and/or in reducing or preventing blockage of the injection point.

In various embodiments the recycle loop 26 is configured to pyrolytically crack at least a portion of the fluid hydrocarbons passing therethrough. The range of temperatures required for the pyrolytic cracking depends on a composition of the fluid hydrocarbons in the recycle loop 26. Some fluid hydrocarbons usually crack at lower temperatures, e.g., above 360° C., while other fluid hydrocarbons usually only crack at higher temperatures close to 550° C. or above. Further fluid hydrocarbons usually crack at temperatures between 360° C. and 550° C. To crack at least a portion of the fluid hydrocarbons, the recycle heat exchanger 28 is configured to transmit thermal energy to the fluid hydrocarbons passing therethrough. In various embodiments, the thermal energy is assessed to increase the temperature of the fluid hydrocarbons above the respective pyrolysis temperature. The thermal energy is assessed to increase the temperature of the fluid hydrocarbons to 360° C. or greater, more preferably 390° C. or greater, preferably 395° C. or greater, preferably 400° C. or greater, more preferably 410° C. or greater. Principally, a pyrolysis temperature may be in the range of 360-550° C. more preferably 390-450° C. The required thermal energy further depends on a temperature of the fluid hydrocarbons entering the recycle loop 26. In various embodiments the temperature and composition of the material entering the recycle loop 26 depends on the shares of fluid hydrocarbons and cracked gases in the separator vessel 12. Primarily the fluid hydrocarbons will pass the recycle loop 26. The cracked gases primarily evaporate in the separator vessel 12 and exit to distillation section. The evaporation of the cracked gases removes some of the thermal energy of the fluid hydrocarbons. The recycle loop 26 provides thermal energy to the fluid hydrocarbons at least partially compensating for the thermal energy removed by evaporation of cracked gases.

In various embodiments, the recycle heat exchanger 28 is configured to enable transfer of the thermal energy required for the fluid hydrocarbons to reach the respective pyrolytic cracking temperature. In various embodiments, for the minimum velocity being about 1 m/s as specified above, the recycle heat exchanger 28 is configured to provide for an increased exposure. Principally, it is possible to increase exposure by increasing the temperature of the heating medium for the recycle heat exchanger 28. In various embodiments, the increased exposure is achieved by increasing the time for the fluid hydrocarbons to pass through the recycle heat exchanger 28, particularly by providing an extended flow path through the recycle heat exchanger 28 and thus extend a residence time of the fluid hydrocarbons in the recycle heat exchanger 28. This particularly allows exposing the fluid hydrocarbons in the recycle heat exchanger 28 to a specific temperature above the temperature of the respective fluid hydrocarbons, such as a temperature not more than 50° C. above the temperature of the respective fluid hydrocarbons, preferably not more than 30° C. above the temperature of the respective fluid hydrocarbons. It has been found that by limiting the exposure temperature to not more than 50° C., built-up of fouling and clogging in the recycle heat exchanger 28 is reduced or prevented.

In various embodiments, the increased exposure is achieved by providing at least a minimum heat exchange surface area for the fluid hydrocarbons to contact while passing the recycle heat exchanger 28. In further embodiments, the minimum heat exchange surface is provided by extending a path length for the fluid hydrocarbons in the recycle heat exchanger 28. Alternatively or additionally to an increased path length, the number of tubes passing the fluid hydrocarbons in the recycle heat exchanger 28 in parallel is increased.

While the composition of the feedstock of plastics material entering into the heating device 11 can be diverse, it was realised that at least some of the easiest cracking fluid hydrocarbons will evaporate before entering the recycle loop 26 such that the fluid hydrocarbons entering the recycle heat exchanger 28 is less diverse than the original feedstock. Further, the minimum heat exchange surface particularly depends on the thermal energy to be transferred therethrough. The thermal energy primarily is a function of the throughput of fluid hydrocarbons and the temperature increase determined for the fluid hydrocarbons. The predetermined thermal energy to be transferred is less dependent on the pyrolysis temperature for the fluid hydrocarbons. This allows dimensioning the minimum heat exchange surface in the recycle heat exchanger 28 as a function of a predetermined throughput of fluid hydrocarbons through the recycle heat exchanger 28.

In various embodiments the throughput of fluid hydrocarbons through the recycle heat exchanger 28 is determined by a predetermined throughput of fresh feed fluid hydrocarbons into the separator vessel 12. In this context, fresh feed fluid hydrocarbons is fluid hydrocarbons that enters the separator vessel 12 for the first time and has not passed the recycle loop 26 before. In various embodiments the fluid hydrocarbons also contains gas. In various embodiments the throughput of fluid hydrocarbons through the recycle heat exchanger 28 is at least eight times the throughput of fresh feed fluid hydrocarbons into the separator vessel 12 in terms of volume, preferably between ten and twenty times the throughput of fresh feed fluid hydrocarbons into the separator vessel 12 in terms of weight. In various embodiments, the minimum heat exchange surface area is determined based on the weight of fresh feed fluid hydrocarbons and is at least 80 m² per predetermined throughput of 3000 kg/h of fresh feed fluid hydrocarbons.

In various embodiments to adjust at least one of the flow velocity or the temperature of the fluid hydrocarbons in the recycle heat exchanger 28, the recycle loop comprises at least one of monitoring means configured to capture a value indicative of the flow velocity and/or the temperature of the fluid hydrocarbons, and control means configured to adjust the flow velocity by adjusting the recycle pump 27 and/or to adjust a temperature of the of the fluid hydrocarbons at the recycle heat exchanger 28. In various embodiments the monitoring means and/or the control means comprises electronic means configured to process the captured flow velocity and/or temperature, and/or to output a command for the control means to adjust accordingly. In various embodiments, the electronic means is a processor or an electronic controller having stored corresponding computer code thereon.

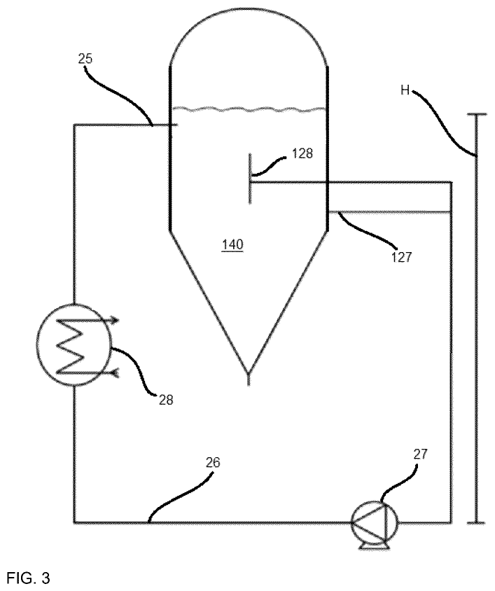

FIG. 3 shows the separator vessel 12 and the recycle loop 26 with further features. The liquid 140 in the lower part of the separator vessel 12 is withdrawn from the separator vessel 12 via one or more outlets. In the illustrated embodiment, two outlets are shown, an internal, preferably substantially central liquid-outlet 128, within the separator vessel's hollow body, and a side liquid-outlet 127. The liquid-outlets 128, 127 may be employed individually or jointly.

As described above, various embodiments are configured to generate a swirling flow pattern. The thus induced centrifugal force will separate different hydrocarbons according to their respective densities in terms of mass per volume. Without being bound by theory, volumes of long straight hydrocarbons tend to have a higher density than shorter or branched hydrocarbons. The long straight hydrocarbons thus tend to swirl further outwards than the other hydrocarbons, such as shorter length or branched hydrocarbons. Having a liquid outlet at a side of the separator vessel 12, such as the side liquid-outlet 127, allows forwarding preferentially the hydrocarbons with long straight chains into the recycle loop. These hydrocarbons with long straight chains also happen to crack more easily than shorter length or branched hydrocarbons. Accordingly, some embodiments with the side liquid-outlet 127 allow to preferentially forward more easily cracking hydrocarbons to the recycle heat exchanger 28. In some embodiments, this may be preferred when the recycle heat exchanger 28 has a lower temperature, for example during a warm-up phase.

In various embodiments, the centrifugal force will also assist in separating solid particles and sediment from the centre of the liquid 140. The positioning of the central liquid-outlet 128 will thus assist in minimizing the quantity of solid particles and sediment entrained with the liquid that is withdrawn via the central liquid-outlet 128. This may assist in avoiding or reducing fouling and blockage of the recycle loop 26, particularly the recycle pump 27 and the recycle heat exchanger 28.

In the illustrated embodiment, the separator vessel 12 and the recycle pump 27 are configured to provide a height difference H between the recycle pump 27 and a level of the liquid in the separator vessel 12. The height difference corresponds at least to a required net positive suction head (NPSH) of the recycle pump 27, that is a head value required to prevent the fluid hydrocarbons in the recycle pump 27 from cavitating. In various embodiments the height difference H is at least 7 meters, more preferably at least 10 meters.

In operation, the separator vessel 12 is filled with substantially pyrolysis temperature, gaseous and fluid hydrocarbons. The fluid hydrocarbons 140 fill the lower conical portion and a lower part of the cylindrical portion up to a level above the side liquid-outlet 127 and/or the central liquid-outlet 128. An upper part of the separator vessel 12 is filled with gaseous material. The recycle pump 27 sucks in fluid hydrocarbons from the separator vessel 12 through the side liquid-outlet 127 and/or the central liquid-outlet 128. The recycle pump 27 forwards the fluid hydrocarbons through the recycle heat exchanger 28 such that a minimum velocity of the fluid hydrocarbons at an inlet of the heat exchanger 28 is reached. The minimum velocity is adjusted to maintain solid particles in suspension and prevent their sedimentation. In various embodiments the minimum velocity is at least 1 m/s. In further embodiments the velocity of the fluid hydrocarbons is at least 2 m/s, preferably at least 5 m/s.

While passing the recycle heat exchanger 28, a portion of the fluid hydrocarbons cracks into shorter chains. As shorter chain hydrocarbons usually have lower boiling points, some of the shorter chained hydrocarbons will change into the gas phase and occupy more volume, such that the velocity of the fluid hydrocarbons in the recycle heat exchanger 28 increases.

In various embodiments the recycle loop 26 comprises a back pressure control element. In various embodiments the back pressure control element is arranged downstream of the recycle heat exchanger 28. The recycle pump 27 and the back pressure control element are configured to maintain the fluid hydrocarbons in the at least one recycle heat exchanger 28 at an increased pressure to supress hydrocarbons from changing into the gas phase. In various embodiments the increased pressure is at least 2 bar, preferably at least 5 bar, more preferably at least 15 bar. The increased pressure inside the recycle heat exchanger 28 suppresses formation of gas bubbles, which provides more surface area for the fluid hydrocarbons to receive heat from the heat exchanger surface (on the other side heated with a heating medium). Gas has poor heat exchanging properties compared to liquid. In some embodiments a higher pressure inside the recycle heat exchanger 28 limits the velocity in the recycle heat exchanger 28 such that noise problems or excess erosion are avoided.

The recycle loop 26 further comprises a recycle inlet 25. The (re) heated fluids pass back to the separator vessel 12 through the recycle inlet 25, carrying heat energy with them, and heating the separator vessel 12 internally. In various embodiments the recycle inlet is arranged separately from the separator vessel inlet 14. In further embodiments the recycle inlet 25 disembogues in the separator vessel inlet 14 such that fresh feed fluid hydrocarbons and recycle feed fluid hydrocarbons mix and enter the separator vessel 12 together.

For example, in various embodiments the fluid hydrocarbons has temperatures above 380° C. In various embodiments the recycle heat exchanger 28 is configured to expose the fluid hydrocarbons in the recycle heat exchanger 28 to an exposure temperature not more than 50° C. above the temperature of the respective fluid hydrocarbons. In various embodiments the fluid hydrocarbons has temperatures above 400° C. and the recycle heat exchanger 28 exposes the fluid hydrocarbons in the recycle heat exchanger 28 to an exposure temperature not more than 30° C. above the temperature of the respective fluid hydrocarbons. It has been found that by further limiting the exposure temperature to not more than 30° C. for fluid hydrocarbons above 400° C., built up of fouling and clogging is reduced or prevented.

The temperature difference between the temperature of the fluid hydrocarbons and the exposure temperature thus is fixed to not more than 50° C. As the temperature difference is fixed within this range the thermal energy transferred to the fluid hydrocarbons likewise is within a limited range. A heat exchange surface of the recycle heat exchanger 28 can thus remain the same for different exposure temperatures. The size of the heat exchange surface of the recycle heat exchanger 28 particularly accounts for the flow velocity predetermined for the fluid hydrocarbons in the recycle heat exchanger and/or for the volume of fresh feed fluid hydrocarbons. In various embodiments, the heat exchange surface area is at least 80 m² per predetermined throughput of 3000 kg/h of fresh feed fluid hydrocarbons. In various embodiments this allows providing the exposure temperature and to provide a flow velocity of at least 1 m/s, preferably 2 m/s, thus operating with reduced generation and/or settling of soot, char and/or other solids in the recycle loop 26.

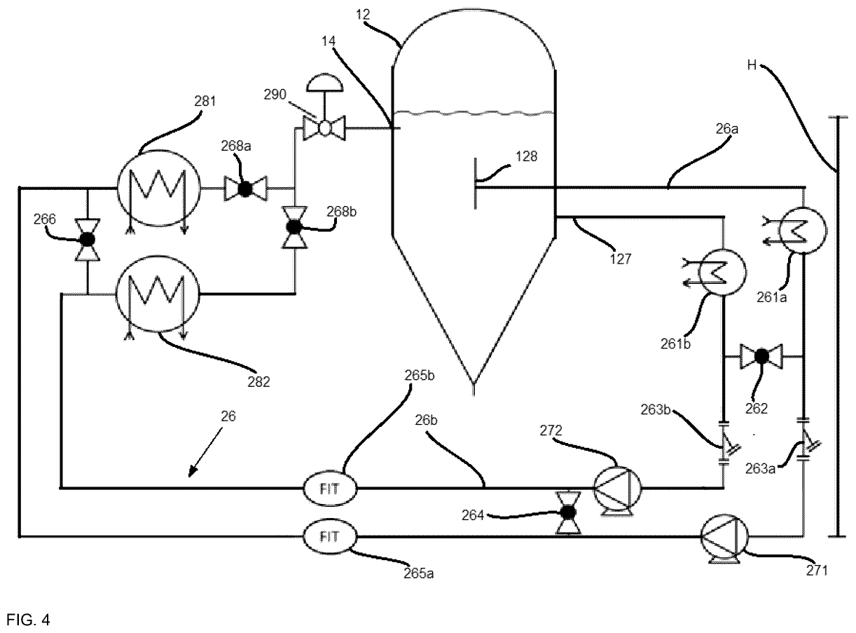

FIG. 4 shows an embodiment of the separator vessel 12 and the recycle loop 26 with further features. In FIG. 4, the recycle loop 26 has first and second recycle loop branches 26a, 26b. The first recycle loop branch 26a extends from the central liquid-outlet 128. The first recycle loop branch 26a comprises a first recycle pump 271 and a first recycle heat exchanger 281. In various embodiments the first recycle loop branch 26a comprises at least one of a first cooling member 261a, a first strainer 263a and a first flowmeter 265a. In various embodiments the first recycle loop branch 26a comprises at least one first recycle pipe configured to conduct fluid hydrocarbons along the first recycle loop branch 26a. The first recycle pipe establishes connections between the central liquid-outlet 128, the first recycle pump 271 and the first heat exchanger 281. In some embodiments the first recycle pipe comprises a thermal insulation configured to reduce dissipation of thermal energy from the fluid hydrocarbons to the environment. The thermal insulation is particularly formed around the pipe and extends essentially along the entire first recycle pipe.

The first cooling member 261a is arranged upstream of the first recycle pump 271 and is configured to reduce the temperature of the fluid hydrocarbons before entering the first recycle pump by at least 1° C., preferably by at least 5° C. In various embodiments the thus reduced temperature can reduce the vapor pressure of the fluid hydrocarbons and thus reduces the tendency for cavitation in the first recycle pump 271 in operation. Accordingly, the reduced temperature of the fluid hydrocarbons reduces an NPSH and thus the height difference H between the first recycle pump 271 and a level of the liquid in the separator vessel 12. In various embodiments the first cooling member 261a is formed by a heat exchanger structure configured to transmit heat from the fluid hydrocarbons to a cooling medium. In various embodiments the first cooling member is formed by a structural measure allowing the fluid hydrocarbons to dissipate heat to the environment. In various embodiments the first cooling member 261a is formed by removing at least a portion of the thermal insulation along a section of the first recycle pipe. In further embodiments the first cooling member 261a comprises a cooling duct configured to circulate a cooling fluid, to receive thermal energy from the fluid hydrocarbons in the first recycle pipe and to dispense the thermal energy to the cooling fluid in the cooling duct. In various embodiments the recycle tube at the first cooling member 261a comprises fins inside the tube to increase a surface area for cooling the fluid hydrocarbons.

In various embodiments the first strainer 263a is arranged along the first recycle loop branch 26a upstream of the first heat exchanger 281. In various embodiments the first strainer is arranged along the first recycle loop branch 26a upstream of the first recycle pump 271. The first strainer 263a is configured to protect the first recycle pump 271 and/or the first heat exchanger 281 by reducing the amount of solids suspended in the fluid hydrocarbons before reaching the first recycle pump 271 and/or the first heat exchanger 281. In various embodiments the first strainer 263a comprises a separator removing solids from the fluid hydrocarbons passing to the first recycle pump 271 and/or the first heat exchanger 281. In various embodiments the first strainer 263a comprises a filter removing solids from the fluid hydrocarbons. In various embodiments the first strainer 263a comprises a sieve or mesh removing solids from the fluid hydrocarbons. In various embodiments the first strainer 263a is configured to allow for frequent or continuous removal of the solids removed from the fluid hydrocarbons.

In various embodiments, the first recycle pump 271 is configured to set a pressure of the fluid hydrocarbons in the first heat exchanger 281 to at least 2 bar, preferably at least 5 bar, more preferably at least 15 bar. The increased pressure inside the first heat exchanger 281 suppresses the gas bubbles which leaves more room for the liquid to exchange heat with the heat exchanger surface (on the other side heated with a heating medium). As gas has poor heat exchanging properties compared to liquid, an increased share of liquid improves heat exchange. A higher pressure inside the first heat exchanger 281 also prevents that the velocity inside the tubes exceed levels causing noise problems or excess erosion at the first heat exchanger 281.

In various embodiments, the first recycle pump 271 is configured as a centrifugal pump. The centrifugal pump is configured to transport fluid hydrocarbons by converting rotational kinetic energy into hydrodynamic energy of the flow of the fluid hydrocarbons. The centrifugal pump comprises an impeller and a housing. The impeller is configured to rotate and thus accelerate the fluid hydrocarbons radially outwards. The housing accommodates the impeller and is configured to guide the fluid hydrocarbons along the impeller and towards an outlet. The impeller increases the pressure and/or flow velocity of the fluid hydrocarbons. In various embodiments the first recycle pump 271 comprises at least two centrifugal pump stages, each stage comprising an impeller stepping up the pressure and/or flow velocity of the fluid hydrocarbons. In various embodiments the centrifugal pump comprises four stages. In various embodiments the pump stages vary the compression rate with the highest compression rate at the first stage and the lowest compression rate at the final stage. This allows reaching higher pressures at the output of the centrifugal pump.

In various embodiments the first recycle pump 271 is a positive displacement pump such as a lobe pump.

In various embodiments the first heat exchanger 281 is a shell and tube heat exchanger. In various embodiments the first heat exchanger 281 corresponds to the recycle heat exchanger 28 discussed further above. In various embodiments the first recycle pump 271 and the first heat exchanger 281 are configured such that the flow velocity of the fluid hydrocarbons is at least about 1 m/s, preferably at least about 2 m/s at an inlet of the tubes of the first heat exchanger 281. A size of the heat exchange surface of the first heat exchanger 281 particularly accounts for the flow velocity predetermined for the fluid hydrocarbons in the first heat exchanger 281 and/or for the volume of fresh feed fluid hydrocarbons. In various embodiments, the heat exchange surface area is at least 80 m² per predetermined throughput of 3000 kg/h of fresh feed fluid hydrocarbons.

In various embodiments the recycle loop 26 provides for the fluid hydrocarbons passing heat exchangers at least twice. In various embodiments the recycle loop 26 is configured to prevent fouling in the section of the recycle pipe connecting the heat exchangers. Particularly, the throughput of fluid hydrocarbons in the recycle pipe connecting the heat exchangers is adjusted to maintain solid particles in suspension and prevent their sedimentation.

In various embodiments the first flowmeter 265a is configured to assess a throughput of fluid hydrocarbons through the first heat exchanger 281. The assessed throughput can give an indication of the flow velocity in the first heat exchanger 281, particularly at its inlet. In various embodiments the assessed throughput of fluid hydrocarbons is passed to control the flow velocity in the first heat exchanger 281. In various embodiments the first recycle loop 26a comprises a first control means configured for receiving a value indicative of the throughput assessed by the first flowmeter 265a and for outputting an adjustment command to the first recycle pump 271 to adjust a flow velocity in the first heat exchanger 281, particularly at its inlet. In various embodiments the first flowmeter 265a and/or the control means comprises electronic means configured to process the indication of the flow velocity, and/or to output a command for the first recycle pump 271 to adjust accordingly. In various embodiments, the electronic means is a processor or an electronic controller having stored corresponding computer code thereon.

The second recycle loop branch 26b extends from the side liquid-outlet 127. The second recycle loop branch 26b comprises a second recycle pump 272 and a second recycle heat exchanger 282. In various embodiments the second recycle loop branch 26b comprises at least one of a second cooling member 261b, a second strainer 263b and a second flowmeter 265b. In various embodiments the second recycle loop branch 26b comprises at least one second recycle pipe configured to conduct fluid hydrocarbons along the second recycle loop branch 26b. The second recycle pipe establishes connections between the side liquid-outlet 127, the second recycle pump 272 and the second heat exchanger 282. In some embodiments the second recycle pipe comprises a thermal insulation configured to reduce dissipation of thermal energy from the fluid hydrocarbons to the environment. The thermal insulation is particularly formed around the pipe and extends essentially along the entire second recycle pipe.

The second cooling member 261b is arranged upstream of the second recycle pump 272 and is configured to reduce the temperature of the fluid hydrocarbons before entering the second recycle pump 272 by at least 1° C., preferably by at least 5° C. In various embodiments the thus reduced temperature can reduce the vapor pressure of the fluid hydrocarbons and thus reduces the tendency for cavitation in the second recycle pump 272 in operation. Accordingly, the reduced temperature of the fluid hydrocarbons reduces an NPSH and thus the height difference H between the second recycle pump 272 and a level of the liquid in the separator vessel 12. In various embodiments the second cooling member 261b is formed by a heat exchanger structure configured to transmit heat from the fluid hydrocarbons to a cooling medium. In various embodiments the second cooling member is formed by a structural measure allowing the fluid hydrocarbons to dissipate heat to the environment. In various embodiments the second cooling member 261b is formed by removing at least a portion of the thermal insulation along a section of the second recycle pipe. In further embodiments the second cooling member 261b comprises a cooling duct configured to circulate a cooling fluid, to receive thermal energy from the fluid hydrocarbons in the second recycle pipe and to dispense the thermal energy to the cooling fluid in the cooling duct. In various embodiments the recycle tube at the second cooling member 261b comprises fins inside the tube to increase a surface area for cooling the fluid hydrocarbons.

In various embodiments the second strainer 263b is arranged along the second recycle loop branch 26b upstream of the second heat exchanger 282. In various embodiments the second strainer 263b is arranged along the second recycle loop branch 26b upstream of the second recycle pump 272. The second strainer 263b is configured to protect the second recycle pump 272 and/or the second heat exchanger 282 by reducing the amount of solids suspended in the fluid hydrocarbons before reaching the second recycle pump 272 and/or the second heat exchanger 282. In various embodiments the second strainer 263b comprises a separator removing solids from the fluid hydrocarbons passing to the second recycle pump 272 and/or the second heat exchanger 282. In various embodiments the second strainer 263b comprises a filter removing solids from the fluid hydrocarbons. In various embodiments the second strainer 263b comprises a sieve or mesh removing solids from the fluid hydrocarbons. In various embodiments the second strainer 263a is configured to allow for frequent or continuous removal of the solids removed from the fluid hydrocarbons.

In various embodiments, the second recycle pump 272 is configured to set a pressure of the fluid hydrocarbons in the second heat exchanger 282 to at least 2 bar, preferably at least 5 bar, more preferably at least 15 bar. The increased pressure inside the second heat exchanger 281 suppresses gas bubbles which leaves more room for the liquid to exchange heat with the heat exchanger surface (on the other side heated with a heating medium). As gas has poor heat exchanging properties compared to liquid, an increased share of liquid improves heat exchange. A higher pressure inside the second heat exchanger 282 also prevents that the velocity inside the tubes exceed levels causing noise problems or excess erosion at the second heat exchanger 282.

In various embodiments, the second recycle pump 272 is configured as a centrifugal pump. The centrifugal pump is configured to transport fluid hydrocarbons by converting rotational kinetic energy into hydrodynamic energy of the flow of the fluid hydrocarbons. The centrifugal pump comprises an impeller and a housing. The impeller is configured to rotate and thus accelerate the fluid hydrocarbons radially outwards. The housing accommodates the impeller and is configured to guide the fluid hydrocarbons along the impeller and towards an outlet. The impeller increases the pressure and/or flow velocity of the fluid hydrocarbons. In various embodiments the second recycle pump 272 comprises at least two centrifugal pump stages, each stage comprising an impeller stepping up the pressure and/or flow velocity of the fluid hydrocarbons. In various embodiments the centrifugal pump comprises four stages. In various embodiments the pump stages vary the compression rate with the highest compression rate at the first stage and the lowest compression rate at the final stage. In various embodiments the second recycle pump 272 is configured to provide a compression different from the first recycle pump 271.

In various embodiments the second recycle pump 272 is a positive displacement pump such as a lobe pump.

In various embodiments the second heat exchanger 282 is a shell and tube heat exchanger. In various embodiments the second heat exchanger 282 corresponds to the recycle heat exchanger 28 discussed further above. In various embodiments the second recycle pump 272 and the second heat exchanger 282 are configured such that the flow velocity of the fluid hydrocarbons is at least about 1 m/s, preferably at least about 2 m/s at an inlet of the tubes of the second heat exchanger 282. A size of the heat exchange surface of the second heat exchanger 282 particularly accounts for the flow velocity predetermined for the fluid hydrocarbons in the second heat exchanger 282 and/or for the volume of fresh feed fluid hydrocarbons. In various embodiments, the heat exchange surface area is at least 80 m² per predetermined throughput of 3000 kg/h of fresh feed fluid hydrocarbons.

In various embodiments the second flowmeter 265b is configured to assess a throughput of fluid hydrocarbons through the second heat exchanger 282. The assessed throughput can give an indication of the flow velocity in the second heat exchanger 282, particularly at its inlet. In various embodiments the assessed throughput of fluid hydrocarbons is passed to control the flow velocity in the second heat exchanger 282. In various embodiments the second recycle loop 26b comprises a second control means configured for receiving a value indicative of the throughput assessed by the second flowmeter 265b and for outputting an adjustment command to the second recycle pump 272 to adjust a flow velocity in the second heat exchanger 282, particularly at its inlet. In various embodiments the second flowmeter 265b and/or the control means comprises electronic means configured to process the indication of the flow velocity, and/or to output a command for the second recycle pump 272 to adjust accordingly. In various embodiments, the electronic means is a processor or an electronic controller having stored corresponding computer code thereon.

In various embodiments the first and/or second centrifugal pump and the back pressure control element 290 control the amount of flow of fluid hydrocarbons through the first and/or second recycle heat exchangers 281, 282. In embodiments with a positive displacement pump as first and/or second recycle pump, the backpressure valve 290 controls the pressure, the positive displacement pump controls the flow velocity.

In various embodiments the first and second recycle loop branches 26a, 26b comprise first and second closing valves 268a, 268b, respectively, and first to third interconnections 262, 264, 266. The first and second closing valves 268a, 268b, and the first to third interconnections 262, 264, 266 are configured to be selectively closed. In various embodiments the first and second recycle loop branches 26a, 26b are configured to bypass at least one of the first and second cooling members 261a, 261b, first and second recycle pumps 271, 272, first and second flowmeters 265a, 265b, and first and second heat exchangers 281, 282 by selectively closing the first to third interconnections 262, 264, 266 and the first and second closing valves 268a, 268b. In various embodiments the first interconnection 262 is configured to communicatively connect the first and second recycle pipes behind the first and second cooling members 261a, 261b and before the first and second strainers 263a, 263b. In various embodiments the second interconnection 264 is configured to communicatively connect the first and second recycle pipes behind the first and second recycle pumps 271, 272 and before the first and second flowmeters 265a, 265b. In various embodiments the third interconnection 266 is configured to communicatively connect the first and second recycle pipes behind the first and second flowmeters 265a, 265b and before the first and second heat exchangers 281, 282. In various embodiments the first and second closing valves 268a, 268b are configured to open alternatingly and communicatively connect on of the first and second heat exchangers 281, 282 to the back pressure control element 290 and thus to the separator vessel inlet 14.

Having the first and second recycle loop branches 26a, 26b with the first and second closing valves 268a, 268b and the first to third interconnections 262, 264, 266 as specified above allows disconnecting at least one of the first and second cooling members 261a, 261b, first and second recycle pumps 271, 272, first and second flowmeters 265a, 265b, and first and second heat exchangers 281, 282 to allow maintenance of the respective structure without shutting down the recycle loop 26 and consequently the apparatus with the separator vessel 12 in its entirety. This helps reducing a downtime of the separator vessel 12.

In further embodiments some of the structures in the first and second recycle loop branches 26a, 26b are configured to run in parallel. For example, the first and second recycle pumps 271, 272 can run in parallel and feed fluid hydrocarbons into at least one of the first and second heat exchanger 281, 282. More specifically, in various embodiments the recycle loop 26 is configured to run one of the first and second recycle pumps 271, 272 at full capacity, while the other one of the first and second recycle pumps 271, 272 is switched off. In various embodiments each of the first and second recycle loop branches 26a, 26b comprise valves configured to close and inhibit backflow through the respective switched off recycle pump 271, 272. In various embodiments the recycle loop 26 is configured to run both, the first and second recycle pumps 271, 272 at equal capacity in a manner that a flow velocity of the fluid hydrocarbons at the inlet of at least one of the first and second heat exchangers 281, 282 is at least about 1 m/s, preferably at least about 2 m/s.

In various embodiments the recycle loop 26 comprises at least one valve configured to selectively close at least one of the first and second cooling members 261a, 261b, the first and second strainers 263a, 263b, the first and second recycle pumps 271, 272, the first and second flowmeters 265a, 265b, and the first and second heat exchangers 281, 282 and thus separate from the remainder of the recycle loop 26.

In various embodiments each of the first and second cooling members 261a, 261b, first and second recycle pumps 271, 272, first and second flowmeters 265a, 265b, and first and second heat exchangers 281, 282 as well as the first and second recycle loop branches 26a, 26b, the first and second closing valves 268a, 268b, and the first to third interconnections 262, 264, 266 comprise heating means allowing to maintain the fluid hydrocarbons contained therein in a liquid state.

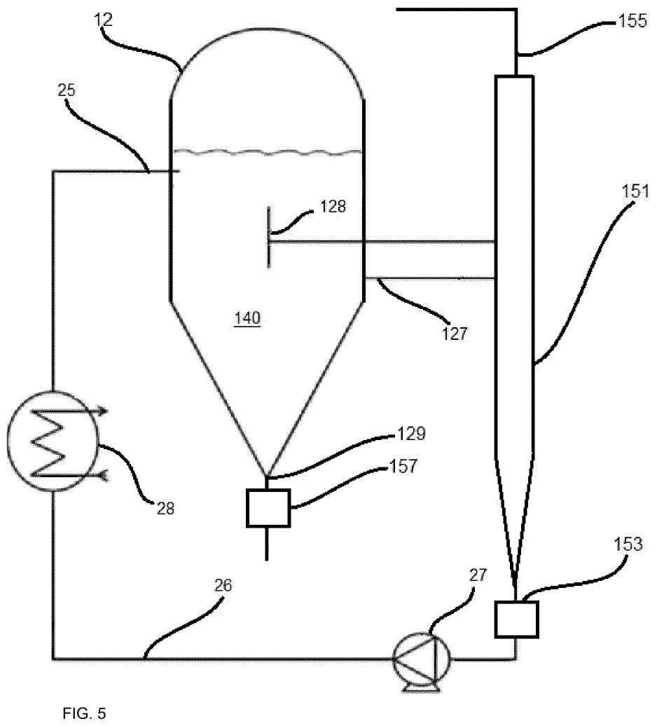

FIG. 5 shows the separator vessel 12 and the recycle loop 26 with further features. As depicted in FIG. 3, the liquid 140 in the lower part of the separator vessel 12 is withdrawn from the separator vessel 12 via one or more outlets. In the embodiment of FIGS. 3-5, two outlets are shown, the internal, preferably substantially central liquid-outlet 128, within the separator vessel's hollow body, and the side liquid-outlet 127. The liquid-outlets 128, 127 may be employed individually or jointly.

In various embodiments as exemplarily depicted in FIG. 5, the recycle loop 26 comprises a degassing section 151. The degassing section 151 is configured to remove fluids in the gas phase from the liquid after entering the recycle loop 26, particularly prior to the recycle pump 27.

As described above, various embodiments are configured to generate a swirling flow pattern in the separator vessel 12. The thus induced centrifugal force will separate different hydrocarbons and will particularly support settling of carbon solids at the carbon discharge point 129 for discharge of the carbon solids. The centrifugal force will also assist in separating solid particles and sediment from the centre of the liquid 140. The positioning of the central liquid-outlet 128 will thus assist in reducing the quantity of solid particles and sediment entrained with the liquid that is withdrawn via the central liquid-outlet 128. However, the swirling motion will also lower an upper level of the liquid 140 in an area adjacent to a central axis of the swirling of the liquid 140. In various embodiments, cracking intensity may vary over time. Accordingly, hydrocarbons change into a gas phase at variable intensity over time. Consequently, the amount of hydrocarbons in the gas phase in the separator vessel 12 changes and the level of the liquid 140 in the separator vessel 12 fluctuates. The side liquid-outlet 127 and the central liquid-outlet 128 may be transitionally above the level of the liquid 140 in the separator vessel 12. In various embodiments, the liquid hydrocarbons crack in the entire volume of the liquid 140 in the separator vessel 12. The hydrocarbons in the gas phase usually rise though the liquid 140 towards an upper portion of the separator vessel 12, but some of the hydrocarbons in the gas phase will be received in the side liquid-outlet 127 and/or the central liquid-outlet 128. It is thus possible that the side liquid-outlet 127 and/or the central liquid-outlet 128 receive hydrocarbons also in a gas phase. Additionally, some of the hydrocarbons entering the side liquid-outlet 127 or the central liquid outlet in a liquid phase may crack while passing through the recycle loop 26 prior to reaching the recycle pump 27. While passing the recycle loop 26, the hydrocarbons in the gas phase agglomerate and form larger volumes of hydrocarbons in the gas phase.

The hydrocarbons in the gas phase have a compressibility different from the compressibility of the hydrocarbons in the liquid phase. When the hydrocarbons in the gas phase occasionally reach the recycle pump 27, the load on the recycle pump changes suddenly. Usually when the hydrocarbons in the gas phase reach the recycle pump 27, the recycle pump 27 experiences less resistance at a given pump cycle rate and moves less mass of hydrocarbons at the given pump cycle rate. While this allows increasing the number of pump cycles per time, or rotations per time for a centrifugal pump, the recycle pump 27 forwards less hydrocarbons in terms of mass per cycle if the hydrocarbons are in a gas phase. Sometimes the recycle pump 27 may reach an operational state outside an operation rated safe for the recycle pump 27. Additionally, when the hydrocarbons in the recycle pump 27 change to the liquid phase, that is, a gas bubble has passed the recycle pump 27, the recycle pump 27 experiences another sudden load variation. Passing the hydrocarbons through the degassing section 151 reduces a share of hydrocarbons in the gas phase, and the degassing section 151 thus reduces stresses on the recycle pump 27.

Further, when the hydrocarbons in the gas phase reach the recycle heat exchanger 28, sections of the recycle heat exchanger 28 heat material that is already cracked. This renders the recycle heat exchanger 28 less effective. The hydrocarbons in the gas phase thermally insulate the hydrocarbons in the liquid phase from portions of the recycle heat exchanger 28. The degassing section 151 renders the recycle heat exchanger 28 more effective.

In various embodiments the degassing section 151 is arranged to extend in a vertical direction. In various embodiments the degassing section 151 is configured to pass the liquid 140 downwards. In various embodiments, the degassing section 151 is a section of the recycle loop 26 with a cross-sectional area larger than a cross-sectional area of a section of the recycle loop 26 connecting the liquid-outlets 128, 127 to the degassing section 151, and of a section of the recycle loop 26 connecting the degassing section 151 with the recycle pump 27. In various examples, a bubble size of a gas bubble of hydrocarbons to be removed from the hydrocarbons in the liquid phase ranges between 200 μm and 500 μm. Gas bubbles of these sizes rise through and with reference to the liquid 140 at velocities between of 0.016 m/s and 0.054 m/s.

In various embodiments the degassing section 151 is arranged to provide for a downward velocity of the liquid hydrocarbons lower than the upward velocity of the gas bubbles. The gas bubbles thus rise through the liquid hydrocarbons, while the liquid hydrocarbons pass to the recycle pump 27. In the degassing section 151 the liquid hydrocarbons flow at a velocity of less than between of 0.016 m/s and 0.054 m/s downwards.

In various embodiments the degassing section 151 comprises a degassing outlet line 155. The hydrocarbons in the gas phase rising in the degassing section 151 discharge via the degassing outlet line 155 and pass to the distillation section.

In various embodiments the recycle loop 26 comprises at least two degassing sections arranged in parallel to each other. In various embodiments the recycle loop 26 bifurcates before the two degassing sections and passes hydrocarbon fluid to both degassing sections. In various embodiments this provides an advantageous flow pattern in the degassing sections. In various embodiments the at least two degassing sections are dimensioned to provide a flow pattern having downward flow velocities not exceeding the upward velocity of the gas bubbles. In various embodiments the recycle loop 26 is configured to selectively pass hydrocarbon fluid to the degassing sections. In various embodiments each of the degassing sections is configured to selectively bypass a respective other degassing section. This allows maintenance of the respectively bypassed degassing section, particularly by removing solids and cleaning. This also allows using only one degassing vessel and thus adapt the volume in the degassing section to the required throughput of fluid hydrocarbons. In various embodiments each of the at least two degassing sections comprises a degassing outlet line. In various embodiments the hydrocarbons from the degassing sections are combined prior to the recycle pump 27. In various embodiments each of the recycle loop branches comprises a degassing section.

In various embodiments the recycle loop 26 comprises a recycle density sensor 153 configured to determine a density of the hydrocarbons passing to the recycle pump 27. The density generally is a substance's mass per unit of volume and in the present context provides an indication for the share of hydrocarbons in the gas phase to hydrocarbons and char particles in the recycle loop 26. Preferably both the density in the recycle loop 26 and of the carbon discharge product is measured. The density sensor 153 allows adapting the operation of the recycle pump 27 to the share of hydrocarbons in the gas phase and/or prevents sudden changes in a load development at the recycle pump 27. This helps reducing loads on the recycle pump 27. The share of hydrocarbons in the gas phase provide an indication as to an increase of hydrocarbons in the gas phase entering the separator vessel 12. The density sensor 153 thus helps determining a level of liquid 140 in the separator vessel 12. In various embodiments the recycle heat exchanger 28 is operated to adjust the level of liquid 140 in the separator vessel 12. In various embodiments the recycle heat exchanger 28 is operated dependent on the density sensor 153 to adjust the level of liquid 140 in the separator vessel 12.

In various embodiments the separator vessel 12 comprises a carbon discharge density sensor 157 adjacent to the carbon discharge point 129. In various embodiments the carbon discharge density sensor 157 is configured to determine a density of a volume inside the separator vessel 12 adjacent to the carbon discharge point 129 for selectively opening the carbon discharge point 129 dependent on a density measurement of the volume of hydrocarbons. A denser volume of hydrocarbons usually has a greater share of solids than a volume of hydrocarbons with lower density. For example, when the density measurement determines that a density of the hydrocarbons adjacent to the carbon discharge point 129 passes a density threshold, the carbon discharge point 129 opens to dispose of hydrocarbons that accumulated at the carbon discharge point 129. This helps making a frequency of disposal of solids dependent on actual accumulation of solids and prevents that fouling builds up to a point making its removal more difficult. In various embodiments this avoids that In various embodiments the carbon discharge density sensor 157 is configured to determine a density of a volume of the hydrocarbons having passed the carbon discharge point 129 and external to the separator vessel 12. In various embodiments, solids are then removed from the hydrocarbons and at least a portion of the liquid hydrocarbon is recirculated back into the separator vessel 12. In various embodiments a difference in density between the recycle loop 26 and the carbon discharge point 129 indicates a share of char particles in the hydrocarbons at the carbon discharge point. The inventors have realised that different compositions of hydrocarbons fed to the separator vessel 12 can lead to different densities of the liquid 140. In some embodiments only measuring the density at the carbon discharge point 129 can thus deliver very different values independently of the share of char particles at the carbon discharge point 129. The density of the hydrocarbons in the recycle loop 26 has been observed to provide a sufficient indication of the density in the bulk of the liquid 140 in the separator vessel 12. Comparing the density at the carbon discharge point 129 and the density in the recycle loop 26 indicates or at least provides a rough estimate of the share of heavy hydrocarbons and/or char particles accumulated at the carbon discharge point 129. In various embodiments, a frequency of carbon discharge at the carbon discharge point is adjusted according to the difference in density between the recycle loop 26 and the carbon discharge point 129. In various embodiments heavy hydrocarbons and/or char particles are discharged when the difference in density between the recycle loop 26 and the carbon discharge point 129 exceeds a threshold.

1. An apparatus for pyrolyzing fluid hydrocarbons to one or more hydrocarbon products, the apparatus comprising:
at least one recycle pump for forwarding fluid hydrocarbons; and
at least one recycle heat exchanger providing at least one tube for the fluid hydrocarbons to pass;
wherein the at least one recycle pump and/or the recycle heat exchanger are configured to establish a flow velocity of at least 1 m/s of the fluid hydrocarbons inside the at least one tube.

2. The apparatus of claim 1, wherein the recycle heat exchanger comprises a heat exchange surface for the fluid hydrocarbons to contact while passing the recycle heat exchanger, wherein the heat exchange surface provides a minimum heat exchange surface area of at least 8 m² per 6000 kg/h of fluid hydrocarbons passing the recycle heat exchanger in operation.

3. The apparatus of claim 1, further comprising a separator vessel comprising:
a recycle inlet arranged to receive pyrolysis temperature, gaseous and fluid hydrocarbons from the at least one recycle heat exchanger;
an upper outlet for exit of gaseous material; and
a lower outlet for exit of fluid hydrocarbons, wherein the lower outlet is configured to pass the fluid hydrocarbons to the at least one recycle pump.

4. The apparatus of claim 3, wherein the separator vessel further comprises a separator vessel inlet arranged to pass fresh feed pyrolysis temperature, gaseous and fluid hydrocarbons into the separator vessel,
wherein the recycle heat exchanger comprises a heat exchange surface for the fluid hydrocarbons to contact while passing the recycle heat exchanger, wherein the heat exchange surface provides a minimum heat exchange surface area of at least 80 m² per 3000 kg/h of fresh feed fluid hydrocarbons entering the separator vessel in operation.

5. The apparatus of claim 4, wherein the apparatus is configured such that the flow ratio of the fluid hydrocarbons entering the separator vessel through the separator vessel inlet and the fluid hydrocarbons exiting the separator vessel through the lower outlet is between 1:1 and 1:20.

6. The apparatus of claim 3, wherein the at least one recycle pump comprises a fluid hydrocarbons inlet, and wherein the separator vessel is configured to have an upper level of the fluid hydrocarbons of at least 7 meters above the fluid hydrocarbons inlet.

7. The apparatus of claim 3, further comprising a recycle pipe, wherein the recycle pipe is configured to pass the fluid hydrocarbons from the lower outlet of the separator vessel to the at least one recycle pump, wherein the recycle pipe is configured to cool the fluid hydrocarbons while passing to the at least one recycle pump.

8. (canceled)

9. The apparatus of claim 1, wherein the at least one recycle heat exchanger is configured to expose the fluid hydrocarbons to a temperature not more than 50° C. above the temperature of the respective fluid hydrocarbons.

10. The apparatus of claim 1, further comprising a back pressure control element configured to maintain the fluid hydrocarbons in the at least one recycle heat exchanger at a pressure of at least 2 bar.

11. The apparatus of claim 1, wherein the at least one recycle pump is a centrifugal pump and/or is arranged upstream of the recycle heat exchanger.

12. The apparatus of claim 1, further comprising at least one heating element configured to selectively heat at least one section of the apparatus.

13. The apparatus of claim 1, comprising at least two recycle heat exchangers, wherein the apparatus is configured to selectively pass fluid hydrocarbons exclusively through one of the at least two recycle heat exchangers.

14. The apparatus of claim 1, further comprising at least one degassing section configured to reduce a share of hydrocarbons in a gas phase from the fluid hydrocarbons prior to entering the recycle pump.

15. The apparatus of claim 14, wherein the degassing section extends in a vertical direction and is configured to pass the fluid hydrocarbons downwards.

16. The apparatus of claim 14, wherein the degassing section is configured to establish a flow velocity of the fluid hydrocarbons of less than 0.054 m/s downwards.

17. The apparatus of claim 14, comprising at least two degassing sections arranged in parallel to each other.

18. The apparatus of claim 8 any preceding claim 8, further comprising a recycle density sensor configured to determine a density of the fluid hydrocarbons passing to the recycle pump.

19. (canceled)

20. (canceled)

21. A method for pyrolysis of fluid hydrocarbons, the process comprising:
forwarding pyrolysis temperature, gaseous and fluid hydrocarbons through a heat exchanger; and
establishing a flow velocity of at least 1 m/s of the fluid hydrocarbons inside the at least one tube.

22. The method of claim 21, further comprising:
providing a separator vessel;
receiving pyrolysis temperature, gaseous and fluid hydrocarbons from the heat exchanger at a recycle inlet of the separator vessel;
exiting of gaseous material at an upper outlet of the separator vessel; and
exiting of fluid hydrocarbons at a lower outlet of the separator vessel, wherein the lower outlet passes the fluid hydrocarbons to the at least one recycle pump.

23. The method of claim 21, wherein the heat exchanger exposes the fluid hydrocarbons to a temperature not more than 50° C. above the temperature of the respective fluid hydrocarbons.

24. (canceled)
